(19) United States
(12) Patent Application Publication
(10) Pub. No.: US 2004/0070908 A1
(43) Pub. Date: Apr. 15, 2004

(54) Overcurrent protection of input/output devices in a data processing system

(75) Inventors: Philip M. Corcoran, Highland, NY (US); Gerald J. Fahr, Wappingers Falls, NY (US); Raymond J. Harrington, Staatsburg, NY (US); Edward J. Seminaro, Milton, NY (US)

Correspondence Address: Floyd A. Gonzalez, IBM Corporation, 2455 South Road, P386, Poughkeepsie, NY, 12601, US

(73) Assignee: International Business Machines Corporation, Armonk, NY

(21) Appl. No.: 10/256,296

(22) Filed: Sep. 27, 2002

(51) Int. Cl. H02H 3/08

(52) U.S. Cl. 361/93.1

(57) ABSTRACT

Method and apparatus to prevent disturbances on the system power busses in a data processing system while communication channels of the system are partitioned and redundant to eliminate interruptions. Power to Direct Access Storage Devices (DASD) and Terminators are powered-on in a slow controlled manner to prevent disturbances on the power busses. This allows for hot plugging of DASD backplanes. Very fast (1u sec.) soft switch circuits along with parasitic (Lparx) storage components provide over current protection from any shorting component or disk drive.

### BACKGROUND OF THE INVENTION

The present invention is directed to a method and apparatus for providing overcurrent protection, and is more particularly directed to providing over current protection for Direct Access Storage Devices (DASD) devices and Input/output (I/O) boards in a data processing system.

U.S. Pat. No. 5,155,648 issued Oct. 13, 1992 to Gauthier for DEVICE FOR PROTECTING A DIRECT CURRENT ELECTRICAL POWER SUPPLY FROM DISTURBANCES CAUSED BY CONNECTING TO IT OR DISCONNECTING FROM IT AN ELECTRONIC SYSTEM discloses a device for protecting a direct current electrical power supply from disturbances caused be connecting to it or disconnecting from it.

U.S. Pat. No. 5,272,584 issued Dec. 21, 1993 to Austruy et al. for HOT-PLUGGING CIRCUIT FOR THE INTERCONNECTION OF CARDS TO BOARDS discloses a hot-plug circuit insuring that the plugging of cards to a board is performed in the hot-plug mode when the cards are supplied from a common power supply.

U.S. Pat. No. 5,572,395 issued Nov. 5, 1996 to Rasums et al. for CIRCUIT FOR CONTROLLING CURRENT IN AN ADAPTER CARD discloses a card for hot-plugging. The circuit includes a FET/feedback circuit for opening and closing the circuit. A latch circuit is provided to turn off the FET within the FET/feedback circuit upon sensing of a transient current through the load.

U.S. Pat. No. 5,587,685 issued Dec. 24, 1996 to Johansson for SYSTEM FOR SUPPRESSING POWER TRANSIENTS WHEN CONNECTING A DISK DRIVE IN A OPERATING RAID SYSTEM discloses individual devices of a redundant array of independent devices coupled to an electrical power supply. A transient suppression circuit isolates the load impedance of a device from the power supply during the replacement or addition of a device in the system while the system is in operation, to minimize unacceptable power transients.

U.S. Pat. No. 5,774,315 issued Jun. 30, 1998 to Mussenden for POWER SURGE SUPPRESSION CIRCUIT FOR HOT PLUG ENVIRONMENTS discloses a surge suppression circuit for gradually charging a capacitance of a device being hot plugged into a system with a current limiting circuit. The current limiting circuit relies on a current sensing resistor in combination with a transistor that turns on when the voltage reaches a certain lever across the current sensing resistor.

U.S. Pat. No. 6,044,424 issued Mar. 28, 2000 to Amin for HOT-PLUG POWER SUPPLY FOR HIGH-AVAILABILITY COMPUTER SYSTEMS discloses a system and method for minimizing disruption of operating power as new power supplies are hot-inserted in a system having a plurality of hot-plug power supplies.

Other backplanes do not totally protect the power busses from disturbances during fault conditions and maintenance activity. Should a short circuit approaching 0.0 ohms occur on the 12 volt power bus in other systems, the entire power system will be affected.

### SUMMARY OF THE INVENTION

Active circuits are used to prevent disturbances on the system power busses in a data processing system while communication channels of the system are partitioned and redundant to eliminate interruptions. Power to Direct Access Storage Devices (DASD) and Terminators are powered-on in a slow controlled manner to prevent disturbances on the power busses. This allows for hot plugging of DASD backplanes. Very fast (1 u sec.) soft switch circuits along with parasitic (Lparx) storage components provide over current protection from any shorting component or disk drive. These circuits will protect against any short from a perfect 0.0 ohm short to resistive shorts. The failing components will be quickly removed from the power bus, minimizing voltage transients and eliminating disturbances to other system functions. Failing backplanes will not upset system operation and can be unplugged and replaced with minimal disruption to the system. Only DASD on the failing back plane needs to be removed to repair the system. All other system functions continue undisturbed. It quickly and completely isolates failing components for the power busses when a fault occurs. Communications lines are twin tailed to all system FRUs affording redundancy to all control and service communication systems.

It is thus an object of the present invention to provide a system and method to isolate faults in a disk drive or terminator from a bulk power bus.

It is another object of the invention to provide a circuit having a Field Effect Transistor (FET) which acts as a high speed switch to turn off power when a fault current is sensed.

It is another object of the invention to provide a soft switch circuit in which parasitic storage provide over current protection from any shorting component.

It is another object of the invention to provide a circuit that responds quick enough when a fault occurs that the series inductance prevents the entire power bus from being disturbed.

It is another object of the invention to provide a method and circuit for hot plugging disk drives and protects the power bus from power faults on the drives and disturbances from hot plugging DASD.

It is another object of the invention to provide a method and circuit for protecting the power bus from power faults on the DASD and transient suppression from hot plugging disk drives.

### BRIEF DESCRIPTION OF THE DRAWINGS

These and other objects will be apparent to one skilled in the art from the following detailed description of the invention taken in conjunction with the accompanying drawings in which:

FIG. 1 is the schematic diagram of the I/O and storage subsystem of a data processing system including the soft switch of the present invention;

FIG. 2 is circuit diagram of the soft switch of the present invention connected between a voltage bus and a disk drive of the data processing system of FIG. 1; and

FIG. 3 is a circuit diagram of the soft switch of the present invention connected between a voltage bus and a SCSI terminators of the data processing system of FIG. 1.

### DESCRIPTION OF THE PREFERRED EMBODIMENT

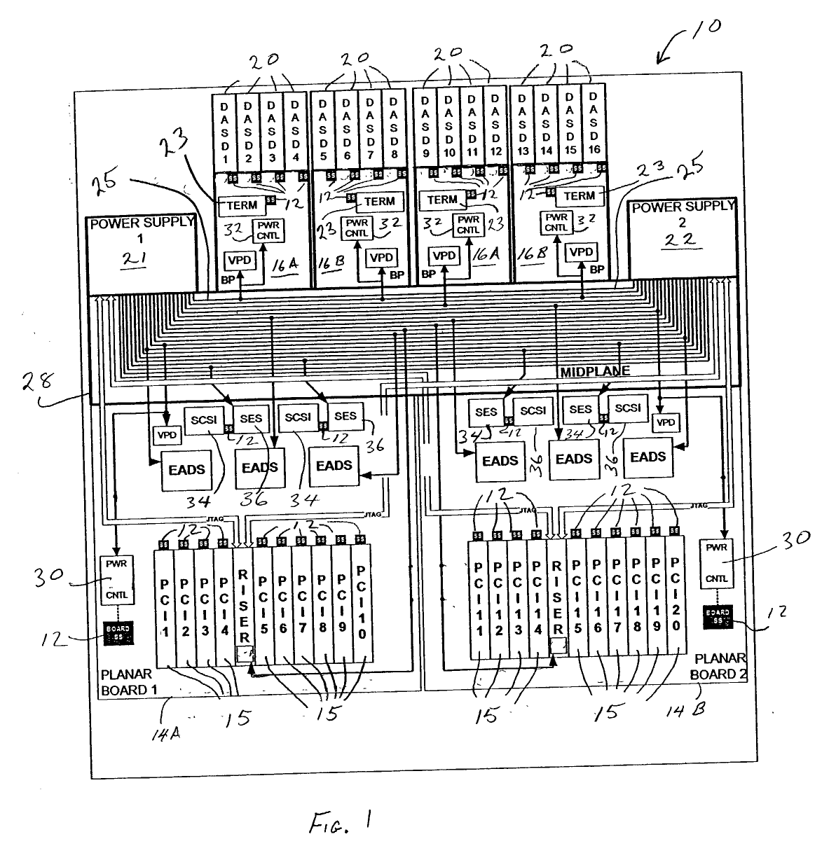

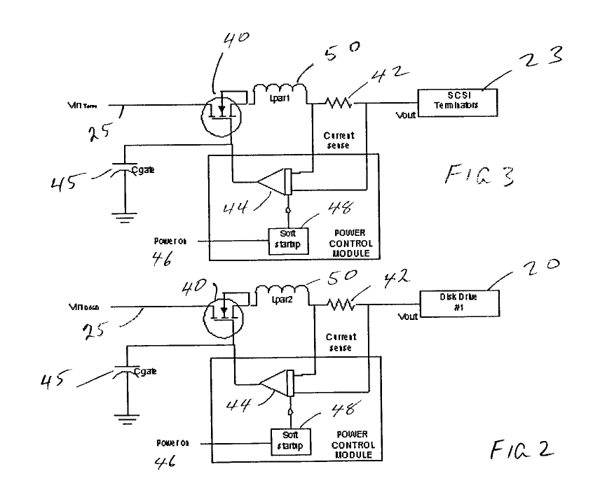

FIG. 1 is a schematic diagram of a data processing system 10 including the soft switch 12 of the present invention. The data processing system may be an IBM pSeries p690 server available from International Business Machines Corporation, and may include a number of planar boards 14A-14B (only two planar boards are shown in FIG. 2 for simplicity). Each planar board includes a number of Peripheral Component Interconnect (PCI) cards 15 for connection into the data processing system, as is well known in the art. For example, planar board 14A includes cards PCI1-PCI10, while planar board 14B includes cards PCI11-PCI20. Each planar board 14 is connected to a pair of backplanes 16A and 16B, and each backplane 16 includes 4 DASD devices 20. Thus, for instance, planar board 14A includes 8 DASD devices 20 (DASD1-DASD8), and planar board 14B includes 8 DASD devices 10 (DASD9-DASD16). Each backplane 16 also includes terminators 23.

Redundant power supplies 21 and 22 supply power over power busses 25 in a midplane 28 between the planar boards 14A-14B and the back planes 16A-16B. Power is supplied to a power control 30 for each board, which controls power to its planar board 14. Each backplane 16 also includes a power control 32 which is connected to a power bus in the midplane 28, and controls power to the backplane. The planar board 16 is protected by the soft switch 12 of the present invention, as well as each of the PCI cards 15. In the backplanes 16, each of the DASD devices 20 and the terminators 23 are protected by the soft switches 12 of the present invention.

In each planar board 14, a Small Computer System Interface (SCSI) module 34 is provided to provide the protocols for communication between the DASD devices and the PCI cards 15, as is well known. Carrier assemblies (not shown) are designed to carry each DASD device 20, and are designed to be hot plugged. The SCSI Environmental Services (SES) modules 36 on the planar boards 14 will assert the SCSI reset line during hot removal and hot plug to minimize disruption on the SCSI bus. The hot plug reset function will be controlled by short, medium and long pins on interposer connectors in the DASD carrier assemblies, as is well known.

FIG. 2 is a circuit diagram of the soft circuit 12 of the present invention when used with a DASD device 20 (in this case, a disk drive). In FIG. 2, a soft switch 12 is connected between a power bus 25 in the mid plane 28 and a DASD 20. The soft switch 12 includes a Field Effect Transistor (FET) 40 and a current sense resistor 42 connected in series between the bus 25 and the DASD device 20. The FET 40 has its drain connected to the power bus 25, and its source connected to the DASD 20. An operational amplifier (OpAmp) 44 is connected as a comparator having one connected on one side of resistor 42, and a second input connected on the other side of resistor 42 to sense voltage drop, and thus current through, the resistor 42. The OpAmp 44 compares the voltage drop across resistor 42 with a set voltage above which the voltage drop across resistor 42 is not allowed to exceed. The output of the OpAmp 44 is connected to the gate of the FET 40. A gate capacitor 45 is connected between the gate of the FET 40 and its ground. A power-on signal 46 is provided by the power control 32 to apply power to the OpAmp 44 to start current sensing. The power-on signal 46 is applied to a soft startup circuit 48 which slowly turns on the OpAmp 44. The OpAmp 44 acts as a constant current source to charge the capacitor 45 and provide gate voltage linearly. The FET 40 ramps on and provides a linearly controlled Vout to the disk drive 20. When a fault occurs on the DASD 20, the output of the OpAmp 44 is reversed, shutting off the gate drive to the FET 40 such that the FET switch 40 turns off, isolating the fault from the power bus 25. The soft startup circuit 48 may include, for instance, an RC tank circuit with an RC time constant of the desired duration. A series inductance 50 is provided between the source of the FET 40 and the resistor 42. The inductance 50 may be provided by parasitic storage of the circuit, or may be supplied by a separate inductor, as may be needed. The inductance 50 supplies a small amount of energy storage which helps to prevent disturbances on the bulk power bus 25. The soft switch circuit 12 protects the power bus 25 from power faults on the DASD 20 and transient suppression from hot plugging disk drives.

FIG. 3 is a circuit diagram of the soft switch 12 of the present invention connected to SCSI terminators 23 of FIG. 1, and includes the same components as the soft switch 12 of FIG. 2.

Thus, a simple circuit is disclosed which is used to prevent disturbances on the system power busses while communication channels are partitioned to eliminate interruptions, allowing for hot plugging of DASD backplanes. Soft switch circuits of the present invention provide very fast (1 u sec) over current protection from any shorting component. These circuits will protect against any short from a perfect 0.0 ohm short to resistive shorts. The failing components will be quickly removed from the power bus minimizing voltage transients and eliminating disturbances to other system functions. The advantage is that failing backplanes will not upset system operation and can be unplugged and replaced with minimal disruption to the system. Only the DASD resident on the failing backplane needs to be removed to repair the system. All other system functions continue undisturbed.

It quickly and completely isolates failing components from the power busses when a fault occurs. Communications lines are twin tailed to all system FRUs affording redundancy to all control and service communication systems. After repair the DASD backplane and disk drives are powered on in a controlled manner to prevent system disturbances.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. An apparatus comprising;
a power supply having a bulk power bus;
a soft switch connected to said bulk power bus;
a current sense resistor connected in series with said soft switch;
a component subject to a current fault connected to said current sense resistor;
a comparator connected to said current sense resistor and said soft switch, said comparator sending an enabling signal to said soft switch to maintain said soft switch in the closed condition when the current through said current sense resistor is normal, and for interrupting said enabling signal to said soft switch for opening said soft switch when said current through said current switch is higher than some normal value thereby detecting a fault in said component; and
inductance between said soft switch and said current sense switch for storing energy preventing said bulk power bus from being disturbed when a fault is detected.

2. The apparatus of claim 1 wherein said soft switch is a FET having its drain connected to said bulk power bus, its source connected to said current sense resistor, and its gate connected to said comparator.

3. The apparatus of claim 2 wherein said comparator is an operational amplifier having one input connected to one side of said current sense resistor, and a second input connected to the other side of said current sense resistor, and powered on by a soft startup circuit such that said operational amplifier applies a linear ramp up voltage to the gate of said FET.

4. The apparatus of claim 3 further comprising a capacitor connected between said gate of said FET and ground for being linearly charged up by said operational amplifier as it is being powered on by said soft startup circuit.

5. The apparatus of claim 1 wherein said inductance is the parasitic inductance of the connection between said FET and said current sense resistor.

6. In a system including a power supply having a bulk power bus and a component subject to a current fault, a circuit comprising;
a soft switch connected to the bulk power bus;
a current sense resistor having one end connected in series with said soft switch and a second end connected to the component subject to a current fault;
a comparator connected to said current sense resistor and said soft switch, said comparator sending an enabling signal to said soft switch to maintain said soft switch in the closed condition when the current through said current sense resistor is normal, and for interrupting said enabling signal to said soft switch for opening said soft switch when said current through said current switch is higher than some normal value thereby detecting a fault in said component; and
inductance between said soft switch and said current sense switch for storing energy preventing said bulk power bus from being disturbed when a fault is detected.

7. The circuit of claim 6 wherein said soft switch is a FET having its drain connected to said bulk power bus, its source connected to said current sense resistor, and its gate connected to said comparator.

8. The circuit of claim 7 wherein said comparator is an operational amplifier having one input connected to one side of said current sense resistor, and a second input connected to the other side of said current sense resistor, and powered on by a soft startup circuit such that said operational amplifier applies a linear ramp up voltage to the gate of said FET.

9. The circuit of claim 8 further comprising a capacitor connected between said gate of said FET and ground for being linearly charged up by said operational amplifier as it is being powered on by said soft startup circuit.

10. The circuit claim 6 wherein said inductance is the parasitic inductance of the connection between said FET and said current sense resistor.

11. In a system including a power supply having a bulk power bus and a component subject to a current fault, a method comprising;
connecting a soft switch to the bulk power bus;
connecting one end of a current sense resistor in series with said soft switch and connecting a second end to the component subject to a current fault;
connecting a comparator to said current sense resistor and said soft switch;
sending an enabling signal from said comparator to said soft switch to maintain said soft switch in the closed condition when the current through said current sense resistor is normal;
interrupting said enabling signal to said soft switch for opening said soft switch when said current through said current switch is higher than some normal value thereby detecting a fault in said component; and
storing energy in an inductance between said soft switch and said current sense switch for preventing said bulk power bus from being disturbed when a fault is detected.

12. The method of claim 11 wherein said soft switch is a FET having its drain connected to said bulk power bus, its source connected to said current sense resistor, and its gate connected to said comparator.

13. The method of claim 12 wherein said comparator is an operational amplifier having one input connected to one side of said current sense resistor, and a second input connected to the other side of said current sense resistor, said method further comprising powering on said operational amplifier by a soft startup circuit such that said operational amplifier applies a linear ramp up voltage to the gate of said FET.

14. The method of claim 13 further comprising connecting a capacitor between said gate of said FET and ground, and linearly charging up said capacitor by said operational amplifier as it is being powered on by said soft startup circuit.

15. The method of claim 14 wherein said inductance is the parasitic inductance of the connection between said FET and said current sense resistor.
